(19) United States
(12) Patent Application Publication
(10) Pub. No.: US 2024/0390836 A1
(43) Pub. Date: Nov. 28, 2024

(54) APPARATUS AND METHOD FOR SUPPLYING OXYGEN

(71) Applicant: OXUS CO., LTD., Gapyeong-gun (KR)

(72) Inventors: Tae Soo LEE, Gapyeong-gun (KR); Jee Soo KWAK, Yongin-si (KR); Seung Kwon OH, Hanam-si (KR); Kang Han LEE, Chuncheon-si (KR); Shin Kyu HAN, Incheon (KR)

(73) Assignee: OXUS CO., LTD., Gapyeong-gun (KR)

(21) Appl. No.: 18/595,779

(22) Filed: Mar. 5, 2024

(30) Foreign Application Priority Data
May 26, 2023 (KR) 10-2023-0068706
Jul. 14, 2023 (KR) 10-2023-0091733

(51) Int. Cl. B01D 53/053; B01D 53/04

(52) U.S. Cl. CPC B01D 53/053; B01D 53/0438; B01D 53/0446; B01D 2256/12; B01D 2257/102; B01D 2259/40007; B01D 2259/40035; B01D 2259/402

(57) ABSTRACT

An apparatus for supplying oxygen includes: a compressor assembly configured to compress air and supply compressed air; an adsorption bed assembly comprising a plurality of adsorption beds configured to adsorb nitrogen from the compressed air supplied by the compressor assembly through a pressure swing adsorption process to produce concentrated oxygen; a cover formed to surround the compressor assembly and the adsorption bed assembly; and a cover configured to accommodate the cover and having an air inlet through which air supplied to the compressor assembly flows. The cover is configured to allow the air supplied through the air inlet to pass through a space where the compressor assembly is disposed and then be discharged to an outside.

### CROSS-REFERENCE TO RELATED APPLICATIONS

This application claims the benefit of Korean Patent Application No. 10-2023-0091733 filed on Jul. 14, 2023 and Korean Patent Application No. 10-2023-0068706 filed on May 26, 2023, which are hereby incorporated by reference in their entirety for all purposes.

### BACKGROUND OF THE INVENTION

The present invention relates to an apparatus and method for concentrating oxygen and supplying the concentrated oxygen.

An oxygen concentration apparatus is an apparatus that separates and concentrates oxygen from the atmosphere, and it is widely used for medical, home, and industrial purposes.

Among various methods of oxygen concentration apparatus, the Pressure Swing Adsorption (PSA) method is based on the principle of using adsorbents to separate and concentrate oxygen and utilizes a process where nitrogen from the air is absorbed by the adsorbent to increase the concentration of oxygen.

A structure that can effectively reduce the noise generated by an oxygen supplying apparatus of the PSA type and efficiently dissipate the heat generated is required.

Furthermore, the oxygen providing apparatus of PSA type requires the ability to supply high-purity oxygen with low power consumption. Specifically, it is necessary to enable energy-efficient operation in a low-flow segment, such as 2.0 Lpm or below, while still being capable of providing a flow rate of 10 Lpm or more.

The information provided in the section of this background is written to enhance the understanding of the invention, and it may include non-conventional information that does not belong to the prior art in the field to which the present invention pertains.

### PRIOR ART DOCUMENTS

Korean Patent Publication No. 10-2000-0030484
Korean Patent Publication No. 10-2003-0017054

### SUMMARY OF THE INVENTION

An object of the present invention is to provide a Pressure Swing Adsorption (PSA) oxygen supply apparatus capable of supplying highly concentrated oxygen with low power consumption in a low-flow segment.

Another object of the present invention is to provide a PSA oxygen supply apparatus capable of supplying highly concentrated oxygen with low power consumption in a low-flow segment.

The technical objects that the present invention aims to achieve are not limited to the object mentioned above, and other technical objects not mentioned explicitly may be understood by those skilled in the art in this technical field from the disclosure provided below.

An apparatus for supplying oxygen according to an embodiment of the present invention includes: a compressor assembly configured to compress air and supply compressed air; an adsorption bed assembly comprising a plurality of adsorption beds configured to adsorb nitrogen from the compressed air supplied by the compressor assembly through a pressure swing adsorption process to produce concentrated oxygen; a cover formed to surround the compressor assembly and the adsorption bed assembly; and a cover configured to accommodate the cover and having an air inlet through which air supplied to the compressor assembly flows. The cover is configured to allow the air supplied through the air inlet to pass through a space where the compressor assembly is disposed and then be discharged to an outside.

The compressor assembly may include a compressor configured to compress the air, and a support frame for supporting the compressor. The compressor may be supported on the support frame in an upside-down state so that a head is positioned downward.

The compressor may be supported on the support frame in a suspended state by a plurality of springs.

The apparatus for supplying oxygen according to another embodiment of the present invention may further include a cooling fan disposed below the support frame, and the support frame may include an air inlet configured so that air flowing by the cooling fan moves upward and flows into the head of the compressor.

The cover may include a first accommodating part in which the adsorption bed assembly is disposed, a second accommodating part in which the compressor assembly is disposed, and a partition wall dividing the first accommodating part and the second accommodating part. The partition wall may include a connection passage connecting the first accommodating part and the second accommodating part so that purge nitrogen discharged from the adsorption bed assembly is able to move to the second accommodating part.

The apparatus for supplying oxygen according to another embodiment of the present invention may further include a heat exchanger disposed below the compressor assembly and the adsorption bed assembly.
The cover may be formed of foam.
The foam may be EPP foam.

The cover may include a pair of lower covers formed to surround a lower portion of the adsorption bed assembly, and a pair of upper covers formed to surround an upper portion of the adsorption bed assembly and the compressor assembly.

The cover may include a first accommodating part in which the adsorption bed assembly is disposed, a second accommodating part in which the compressor assembly is disposed, and a partition wall dividing the first accommodating part and the second accommodating part. The cover may be configured to form a first to third cooling pathway formed by air supplied through the air inlet and purge nitrogen discharged from the adsorption bed assembly. The first cooling pathway may be configured so that the air introduced through the air inlet sequentially passes through a space where the compressor assembly is placed, the partition wall, and a side where the adsorption bed assembly is placed, and is then discharged to the outside. The second cooling pathway may be configured so that air introduced through the air inlet sequentially passes through the partition wall, a space where the controller is placed, the partition wall, a space where the compressor is placed, the partition wall, and a side where the adsorption bed assembly is placed, and is then discharged to the outside. The third cooling pathway may be configured so that air introduced through the air inlet flows into an intake air filter and the adsorption bed assembly, and purge nitrogen discharged from the adsorption bed assembly sequentially flows through the partition wall, a space where the compressor assembly is placed, the partition wall, and a side where the adsorption bed assembly is placed, and is then discharged to the outside.

An apparatus for supplying oxygen according to another embodiment of the present invention includes: a compressor that supplies compressed air; a first adsorption bed and a second adsorption bed for generating concentrated oxygen by alternately adsorbing nitrogen from the compressed air supplied by the compressor by a pressure swing adsorption method; a process control valve configured to adjust flow of the compressed air supplied to the first and second adsorption beds and passages for discharging adsorbed nitrogen discharged from the first and second adsorption beds; an upper equalization valve configured to selectively communicate with a first concentrated oxygen passage and a second concentrated oxygen passage for guiding the concentrated oxygen respectively discharged from the first and second adsorption beds; and a controller that controls the process control valve and the upper equalization valve respectively based on process pressures in the first and second adsorption beds. The controller controls to perform a pressurization process in which the pressurized air is supplied to the first adsorption bed to pressurize the first adsorption bed and generate the concentrated oxygen, an upper equalization process in which the first and second oxygen passages are communicated with each other by the upper equalization valve to allow at least a portion of the concentrated oxygen discharged from the first adsorption bed to flow into the second adsorption bed, and an upper and lower equalization process in which lower ends of the first and second adsorption beds are communicated with each other. The controller controls such that a ratio of a minimum pressure to a maximum pressure of a process pressure profile in the first adsorption bed during the upper equalization process is different from each other in a high flow rate region and a low flow rate region where a flow rate is lower than the high flow rate region. The controller controls such that a ratio of the minimum pressure to the maximum pressure of the process pressure profile within the first adsorption bed during the upper equalization process is set to be smaller in the low flow rate region than in the high flow rate region.

In the low flow rate region the ratio of the minimum pressure to the maximum pressure in the process pressure profile within the first adsorption bed during the upper equalization process is a value in a range of 45 to 55%, and in the high flow rate region the ratio of the minimum pressure to the maximum pressure of the process pressure profile in the first adsorption bed during the upper equalization process is a value in the range of 75 to 85%.

A duration time of the upper equalization process in the low flow rate section may be set to be longer than the duration time of the upper equalization process in the high flow rate section.

The apparatus for supplying oxygen according to another embodiment of the present invention may further include one of more rinse orifices installed in a connection passage connecting the first concentrated oxygen passage and the second concentrated oxygen passage.

The controller may be configured to perform process control based on usage flow rate calculated by the following equation.

$$F = L \frac{Δ P}{Δ t} 60 \qquad [ Equation ]$$

Here, L is a volume of an oxygen tank, ΔP is a difference between a maximum pressure and a minimum pressure in the oxygen tank during a consumption process of consuming oxygen, and Δt is a time interval between a point of a maximum pressure and a point of a minimum pressure with the oxygen tank during the consumption process.

An apparatus for supplying oxygen according to another embodiment of the present invention includes: a compressor that supplies compressed air; a first adsorption bed and a second adsorption bed for generating concentrated oxygen by alternately adsorbing nitrogen from the compressed air supplied by the compressor by a pressure swing adsorption method; a process control valve configured to adjust flow of the compressed air supplied to the first and second adsorption beds and passages for discharging adsorbed nitrogen discharged from the first and second adsorption beds; an upper equalization valve configured to selectively communicate with a first concentrated oxygen passage and a second concentrated oxygen passage for guiding the concentrated oxygen respectively discharged from the first and second adsorption beds; and a controller that controls the process control valve and the upper equalization valve respectively based on process pressures in the first and second adsorption beds. The controller controls to perform a pressurization process in which the pressurized air is supplied to the first adsorption bed to pressurize the first adsorption bed and generate the concentrated oxygen, an upper equalization process in which the first and second oxygen passages are communicated with each other by the upper equalization valve to allow at least a portion of the concentrated oxygen discharged from the first adsorption bed to flow into the second adsorption bed, and an upper and lower equalization process in which lower ends of the first and second adsorption beds are communicated with each other. The controller is configured to perform a process control based on usage flow rate calculated by the following equation.

$$F = L \frac{Δ P}{Δ t} 60 \qquad [ Equation ]$$

Here, L is a volume of an oxygen tank, ΔP is a difference between a maximum pressure and a minimum pressure in the oxygen tank during a consumption process of consuming oxygen, and Δt is a time interval between a point of a maximum pressure and a point of a minimum pressure with the oxygen tank during the consumption process.

A method for supplying oxygen using a first adsorption bed and a second adsorption bed each configured to produce concentrated oxygen by nitrogen adsorption, and an oxygen tank configured to store the concentrated oxygen produced by the first and second adsorption beds, to supply concentrated oxygen in a pressure swing adsorption method, includes: a pressurization process in which pressurized air is supplied to the first adsorption bed to pressurize the first adsorption bed and generate the concentrated oxygen; an upper equalization process in which rear ends of the first and second adsorption beds are communicated with each other to allow at least a portion of the concentrated oxygen discharged from the first adsorption bed to move to the second adsorption bed; and an upper and lower equalization process in which lower ends of the first and second adsorption beds are communicated with each other. The upper equalization process is performed such that a ratio of a minimum pressure to a maximum pressure of a process pressure profile in the first adsorption bed during the upper equalization process is different from each other in a high flow rate region and a low flow rate region where a flow rate is lower than the high flow rate region. A ratio of the minimum pressure to the maximum pressure of the process pressure profile within the first adsorption bed during the upper equalization process is set to be smaller in the low flow rate region than in the high flow rate region.

In the low flow rate region the ratio of the minimum pressure to the maximum pressure in the process pressure profile within the first adsorption bed during the upper equalization process may be a value in a range of 45 to 55%, and in the high flow rate region the ratio of the minimum pressure to the maximum pressure of the process pressure profile in the first adsorption bed during the upper equalization process may be a value in the range of 75 to 85%.

A duration time of the upper equalization process in the low flow rate section may be set to be longer than the duration time of the upper equalization process in the high flow rate section.

The process control may be performed based on usage flow rate calculated by the following equation.

$$F = L \frac{Δ P}{Δ t} 60 \qquad [ Equation ]$$

Here, L is a volume of an oxygen tank, ΔP is a difference between a maximum pressure and a minimum pressure in the oxygen tank during a consumption process of consuming oxygen, and Δt is a time interval between a point of a maximum pressure and a point of a minimum pressure with the oxygen tank during the consumption process.

According to the present invention, it is possible to reduce the noise generated by the oxygen supply apparatus using the pressure swing adsorption method and effectively dissipate the heat generated.

According to the present invention, it is possible to supply high-purity concentrated oxygen with low power consumption in the low-flow section.

In addition to the effects mentioned, various other effects that can be obtained or anticipated due to the embodiments of the present invention are directly or implicitly disclosed in the detailed description of the embodiments of the invention.

### BRIEF DESCRIPTION OF THE DRAWINGS

The attached drawings are provided to facilitate an understanding of the present invention and offer examples of embodiments of the invention, in conjunction with a detailed description. However, the technical features of the present invention are not limited to specific drawings. Features disclosed in each drawing can be combined to form new embodiments. The embodiments described in this specification can be better understood by referring to the accompanying drawings, where similar reference numerals denote identical or functionally similar elements.

FIG. 1 is a perspective view schematically showing an oxygen supply apparatus according to an embodiment of the present invention.

FIG. 2 is a rear perspective view schematically showing an oxygen supply apparatus according to an embodiment of the present invention.

FIG. 3 is a perspective view showing a state where a part of the case of the oxygen supply apparatus according to an embodiment of the present invention is removed.

FIG. 4 is an exploded perspective view of the upper cover of the oxygen supply apparatus according to an embodiment of the present invention.

FIG. 5 is an exploded perspective view of the lower cover of the oxygen supply apparatus according to an embodiment of the present invention.

FIG. 6 is a perspective view showing a state where a part of the upper cover of the oxygen supply apparatus according to an embodiment of the present invention is removed.

FIG. 7 is a perspective view of the view shown in FIG. 6, but from a different angle.

FIG. 8 is a front view of the view shown in FIG. 6.

FIG. 9 is an exploded perspective view showing the adsorption bed assembly and compressor separated from the view in FIG. 6.

FIG. 10 is a perspective view showing the adsorption bed assembly and lower cover of the oxygen supply apparatus according to an embodiment of the present invention.

FIG. 11 is a perspective view showing a state where a part of the lower cover is removed from the view in FIG. 10.

FIG. 12 is a perspective view showing the compressor module and cooling fan of the oxygen supply apparatus according to an embodiment of the present invention.

FIG. 13 is a perspective view showing the heat exchanger of the oxygen supply apparatus according to an embodiment of the present invention.

FIG. 14 is a bottom view showing the state of the oxygen supply apparatus with the heat exchanger installed, according to an embodiment of the present invention.

FIG. 15 is a block diagram for explaining the cooling flow path of the oxygen supply apparatus according to an embodiment of the present invention.

FIG. 16A and FIG. 16B are diagrams for explaining the first cooling flow path of the oxygen supply apparatus according to an embodiment of the present invention.

FIG. 17A to FIG. 17C are diagrams for explaining the second cooling flow path of the oxygen supply apparatus according to an embodiment of the present invention.

FIG. 18A and FIG. 18B are diagrams for explaining the third cooling flow path of the oxygen supply apparatus according to an embodiment of the present invention.

FIG. 19 is a diagram that schematically shows the oxygen supply apparatus according to an embodiment of the present invention.

FIG. 20 is a schematic block diagram of the control elements of the oxygen supply apparatus according to an embodiment of the present invention.

FIG. 21 is a diagram illustratively showing the state of the pressurization process in which oxygen supply is carried out by the first adsorption bed of the oxygen supply apparatus according to an embodiment of the present invention.

FIG. 22 shows the pressure profiles within the first and second adsorption beds during the process when the oxygen supply apparatus, according to an embodiment of the present invention, operates in a low-flow section with a small usage flow rate, particularly at a flow rate of 0.5 Lpm.

FIG. 23 shows the pressure profiles within the first and second adsorption beds during the process when the oxygen supply apparatus, according to an embodiment of the present invention, operates in a high-flow section with a large usage flow rate, particularly at a flow rate of 10.0 Lpm.

The drawings referenced above should not necessarily be understood as drawn to scale, but rather as providing a simplified representation of various features illustrative of the basic principles of the invention. For instance, certain design features of the invention, including specific dimensions, orientations, locations, and shapes, may be determined in part by the intended application and use environment.

### DETAILED DESCRIPTION OF THE INVENTION

Hereinafter, referring to the attached drawings, a detailed description is provided to enable those skilled in the art to easily implement embodiments of the present invention. However, the present invention can be implemented in various forms and is not limited to the described embodiments.

The terminology used in this specification is intended for the purpose of describing specific embodiments and is not intended to limit the present invention. As used in this specification, singular forms are intended to include plural forms unless the context clearly indicates otherwise. The terms “comprises” and/or “comprising” as used in this specification indicate the presence of specified features, integers, steps, operations, elements, and/or components, but do not exclude the presence or addition of one or more other features, integers, steps, operations, elements, and/or components, or groups thereof. As used in this specification, the term “and/or” includes any and all combinations of one or more of the associated items listed. The term “coupled” signifies a physical relationship between two components in which they are directly connected or indirectly connected through one or more intermediary components.

In describing the components of the present invention, terms such as ‘first,’ ‘second,’ ‘A,’ ‘B,’ ‘(a),’ ‘(b),’ and so on may be used. These terms are used to distinguish the components from one another, and they do not limit the essence, order, or sequence of the respective components. When a component is stated to be ‘connected,’ ‘coupled,’ or ‘attached’ to another component, it should be understood that the component can be directly connected, coupled, or attached, but there may also be another component ‘connected,’ ‘coupled,’ or ‘attached’ between them.

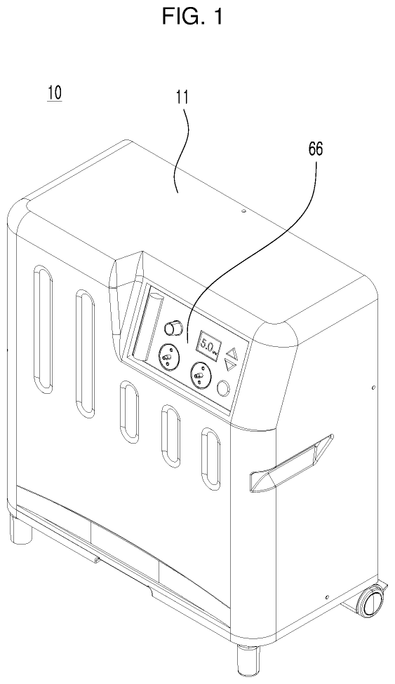

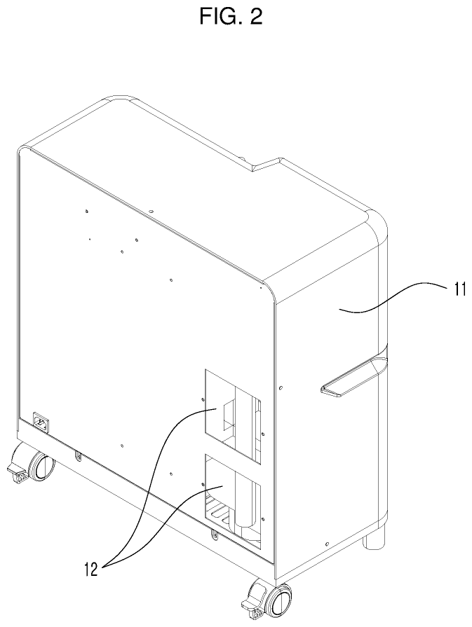

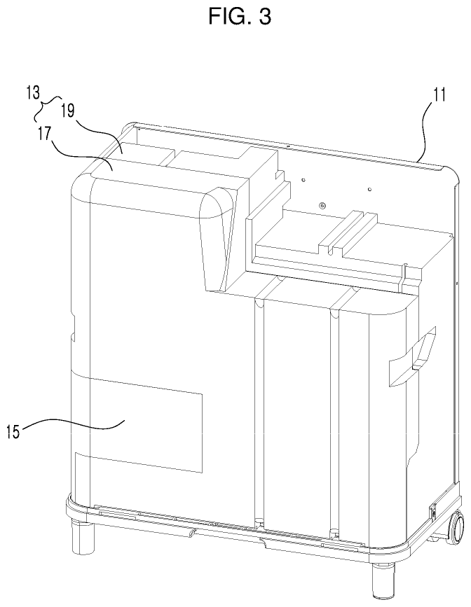

FIG. 1 is a perspective view schematically showing an oxygen supply apparatus according to an embodiment of the present invention, and FIG. 2 is a rear perspective view schematically showing an oxygen supply apparatus according to an embodiment of the present invention. An oxygen supply apparatus 10 according to an embodiment of the present invention is configured to generate concentrated oxygen through the adsorption of nitrogen by pressurizing a gas, such as air, and releasing the adsorbed nitrogen. Referring to FIG. 1 and FIG. 2, the oxygen supply apparatus 10 according to an embodiment of the present invention includes a case 11. In this embodiment of the present invention, concentrated oxygen is generated and supplied through a pressure swing adsorption method utilizing multiple adsorption beds. Components for generating concentrated oxygen can be accommodated within the case 11. An interface 66 for displaying input and output information may be provided on the case 11.

A pair of first covers, i.e., an upper cover 13, and a pair of second covers, i.e., a lower cover 15, are arranged within the case 11. The upper covers 13 and lower covers 15 can be formed from a foam material, such as Expanded Polypropylene (EPP) foam, which has excellent heat resistance, durability, and ease of manufacture. The upper cover 13 and lower cover 15 are configured to be combined with each other to accommodate the elements for generating concentrated oxygen, as will be described below.

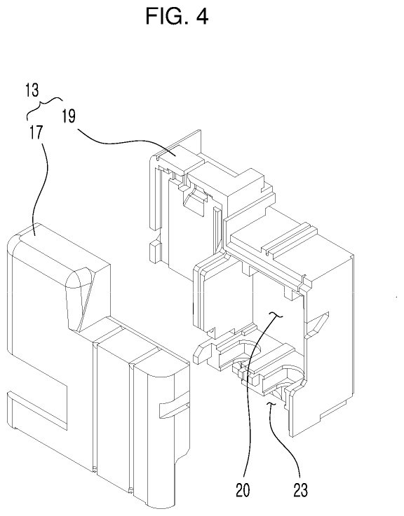

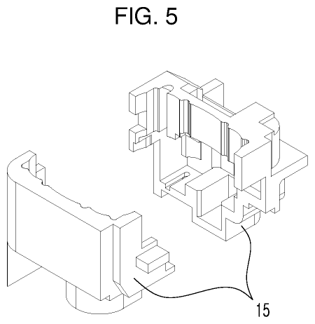

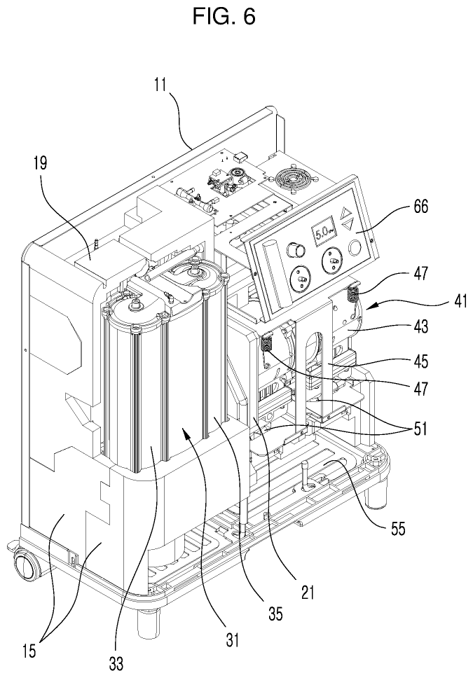

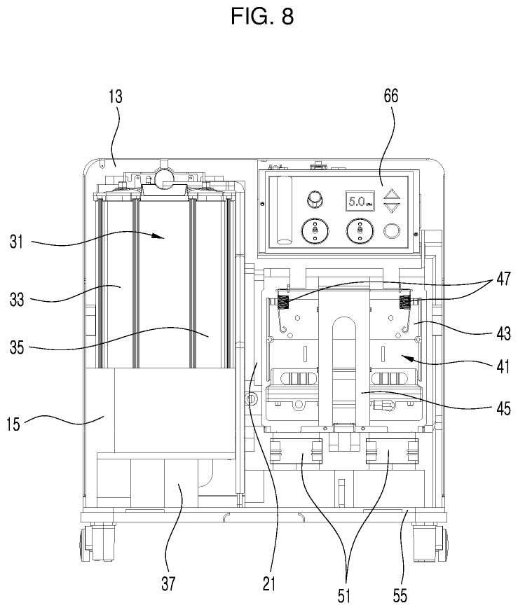

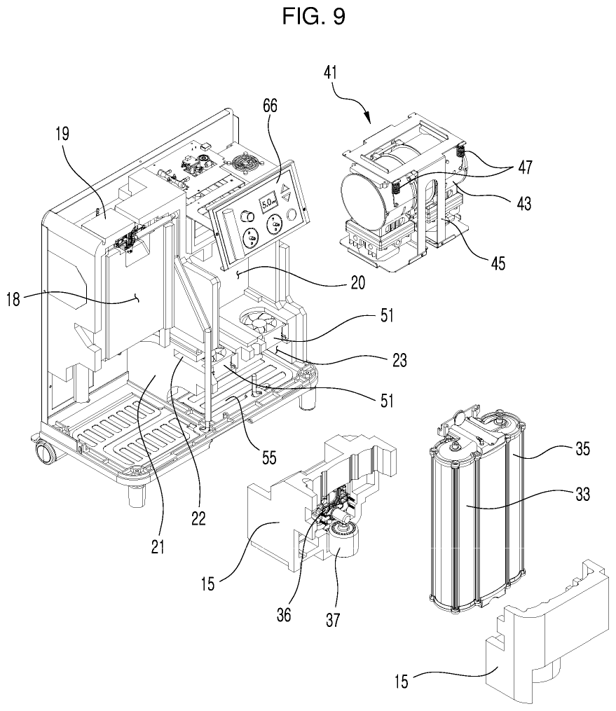

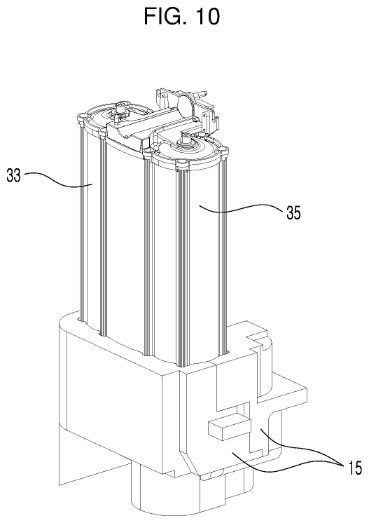

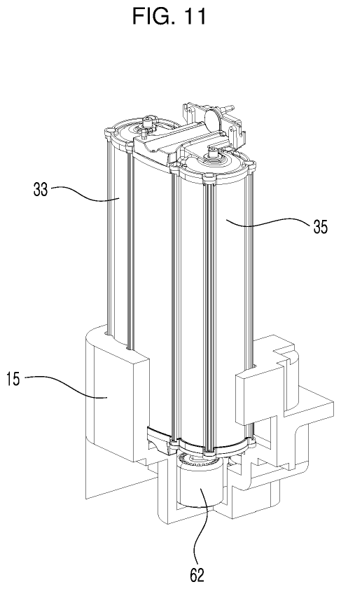

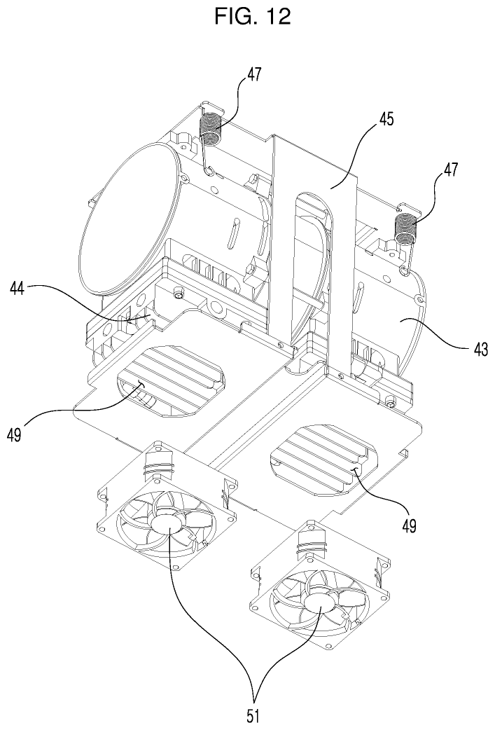

Referring to FIG. 4, the upper cover 13 includes first and second upper covers 17 and 19 arranged to face each other. The first and second upper covers 17 and 19 form a first accommodating part 18 that accommodates an adsorption bed assembly 31 and a second accommodating part 20 that accommodates a compressor assembly 41. The second upper cover 19 includes a partition wall 21 that partitions the first and second accommodating parts 18 and 20. Furthermore, the second upper cover 19 forms a third accommodating part 23 located beneath the second accommodating part 20, as shown in FIGS. 6 to 9, where a cooling fan 51 for cooling the compressor assembly 41 is positioned within the third accommodating part 23.

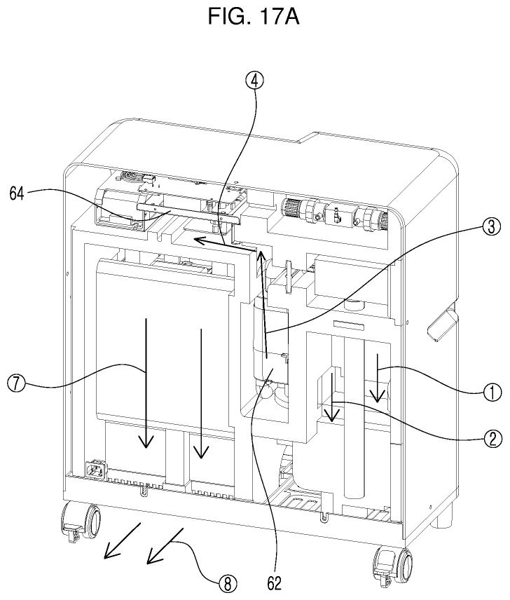

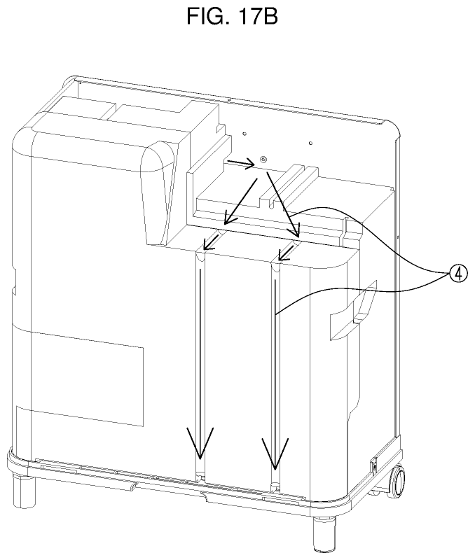

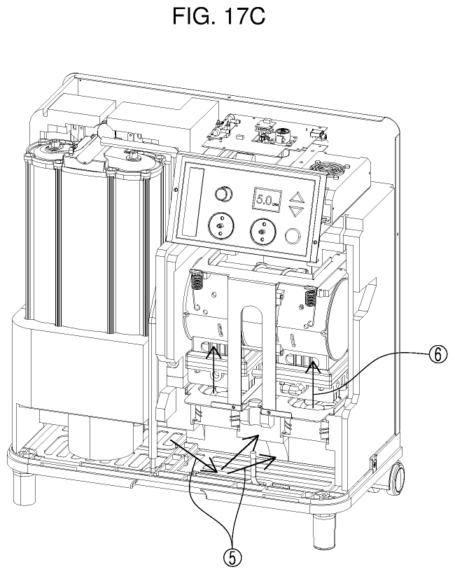

Referring to FIG. 17A, an intake muffler 62 to reduce the noise of the suction air before being supplied to the compressor assembly 41 may be placed in the space formed in the upper cover 13. The space where an intake silencer 62 is placed can be positioned between the adsorption bed assembly 31 and the compressor assembly 41.

The adsorption bed assembly 31 includes a first adsorption bed 33 and a second adsorption bed 35, and can generate concentrated oxygen through a pressure swing adsorption method in which nitrogen adsorption takes place alternately in the first and second adsorption beds 33 and 35. The adsorption bed assembly 31 is configured to generate concentrated oxygen through nitrogen adsorption by pressurization and the discharge of adsorbed nitrogen. The first and second adsorption beds 33 and 35 are designed to perform these processes alternately. Roughly, while the generation of concentrated oxygen by nitrogen adsorption occurs in the first adsorption bed 33, the discharge of adsorbed nitrogen takes place in the second adsorption bed 35, and vice versa, while the generation of concentrated oxygen by nitrogen adsorption in the second adsorption bed 35, the discharge of adsorbed nitrogen occurs in the first adsorption bed 33.

Referring to FIG. 2, the case 11 may be equipped with an air inlet 12 for inflow of air to the adsorption bed assembly 31. The air inlet 12 can be formed on the rear part of the case 11, and a plurality of air inlets 12 may be provided to allow for use in dusty or high-temperature environments. The air that flows in through the air inlet 12 can be supplied to the adsorption bed assembly 31 after passing through an intake filter 14.

Furthermore, as known in the art, a process control valve 36 for regulating the supply of air to the first and second adsorption beds 33 and 35 and the discharge of nitrogen, as well as an exhaust silencer 37 to reduce the noise generated by the discharged nitrogen gas, may be provided. The process control valve and the exhaust duct can be provided in the adsorption bed assembly 31. The process control valve 36 and the exhaust silencer 37 can be positioned at the bottom of the first and second adsorption beds 33 and 35, and the bottom portion of the first and second adsorption beds 33 and 35, the process control valve 36, and the exhaust silencer 37 may be surrounded by a pair of lower covers 15.

As known in the art, the adsorption bed assembly 31 is configured to perform a series of processes, including a pressurization process that supplies pressurized air to pressurize the adsorption bed 33 and generate concentrated oxygen, an upper equalization process that connects the lower ends of the first adsorption bed 33 and the second adsorption bed 35 to achieve a pressure equalization in upper parts, and a lower equalization process that connects the lower ends of the first adsorption bed 33 and the second adsorption bed 35 following the upper equalization process to achieve an upper and lower pressure equalization. Through these processes, concentrated oxygen is generated from pressurized air. The first and second adsorption beds 33 and 35 can generate oxygen-enriched gas by selectively removing nitrogen from the air using an adsorbent with nitrogen adsorption characteristics based on the pressure, such as zeolite, to increase the oxygen concentration.

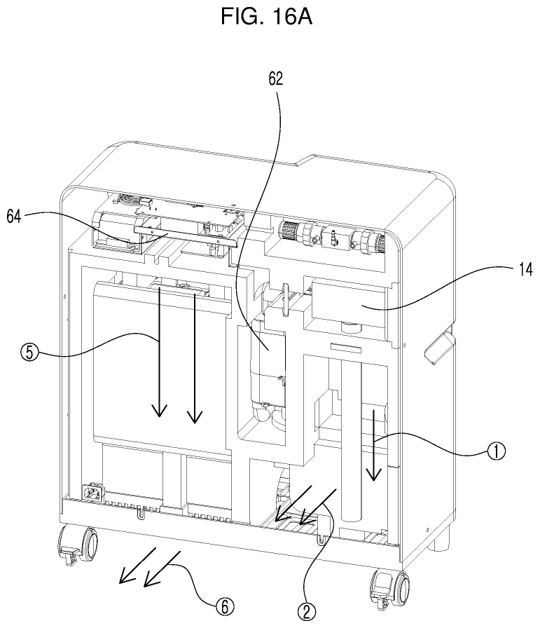

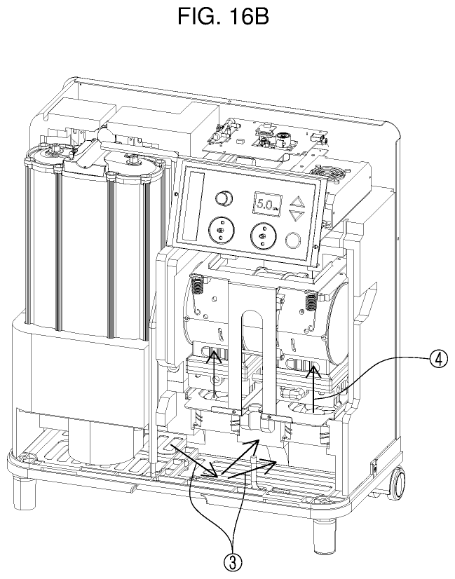

A controller 64 may be provided to control the operations of the process control valve 36, the compressor 43, and the like to perform the series of processes for generating concentrated oxygen as described. As shown in FIG. 16A, the controller 64 can be positioned above the adsorption bed assembly 31 and may be located in a space formed in the upper cover 13.

The compressor assembly 41 compresses air and supplies compressed air to the adsorption bed assembly 31. The compressor assembly 41 may include a compressor 43 for compressing air and a support frame 45 for supporting the compressor 43. The support frame 45 can be fixed within the upper cover 13 and is configured to support the compressor 43. The support frame 45 may form guides to restrict lateral movement of the compressor 43 that may occur when the oxygen supply apparatus 10 is moved or when the compressor 43 is started.

The compressor 43 is installed upside down with a head 44 located below and a bottom facing upwards, and it may be suspended by a plurality of support springs 47 hanging from the support frame 45. For example, the compressor 43 may be a BLDC compressor. Four support springs 47 may be arranged to support four corners of the top of the compressor 43. The support frame 45 may form an air inlet 49 for air intake for cooling located below the head 44 of the compressor 43. A cooling fan 51 for introducing air for cooling into a space where the compressor 43 is located may be positioned below the air inlet 49. The upward airflow generated by the cooling fan 51 can flow through the air inlet 49 into the space where the compressor 43 is located, allowing for the cooling of the compressor 43, especially the head 44.

The compressed air discharged from the compressor 43 is supplied to the first and second adsorption beds 11 and 13 through the process control valve 36. The process control valve 36 operates to enable each process for the production of concentrated oxygen through flow regulation.

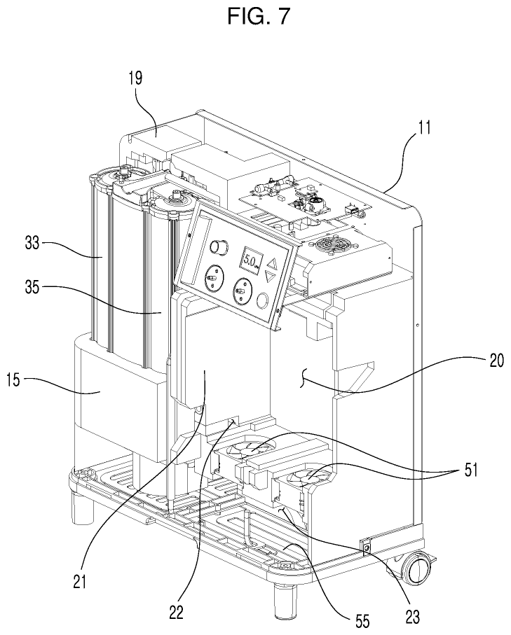

The exhaust gas discharged from the adsorption bed assembly 31 as described above, i.e., purged nitrogen is configured to be directed to the second accommodating part 20 where the compressor 43 is located and then exhausted to the outside. To achieve this, as shown in FIG. 7, a connecting passage 22 is formed in the partition wall 21 of the upper cover 13, connecting the first accommodating part 18 where the adsorption bed assembly 31 is placed and the second accommodating part 20 where the compressor assembly 41 is placed. Consequently, the exhaust gas is exhausted to the outside via the second accommodating part 20 where the compressor assembly 41 is located, minimizing the transmission of exhaust noise to the outside and allowing the exhaust gas to be mixed with the incoming air introduced by the cooling fan 51 described above before being exhausted outside.

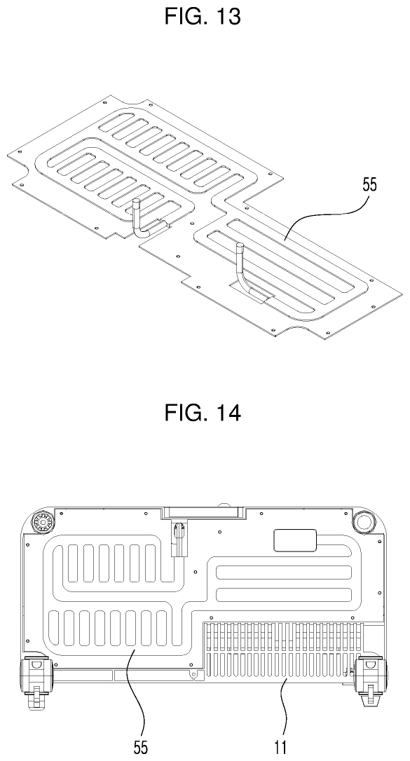

As shown in FIGS. 13 and 14, a heat exchanger 55 may be installed on the bottom of the case 11 near the lower part of the cooling fan 51. The heat exchanger 55 is one of the components used to cool the high-temperature air discharged from the compressor 43 and is positioned closely to the cooling fan 51 to dissipate internal heat through heat exchange with external air. The heat exchanger 55 can be arranged to face the lower part of the compressor assembly 41 and the lower part of the adsorption bed assembly 31. The heat exchanger 55 may be implemented as a roll-bond evaporator type, and it cools down the heat by the air introduced by the operation of the cooling fan 51 and has its underside in contact with the external atmosphere.

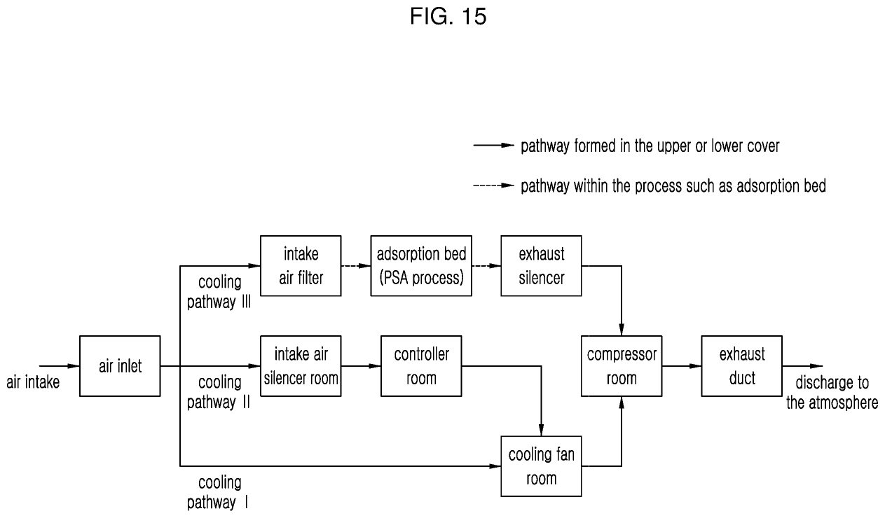

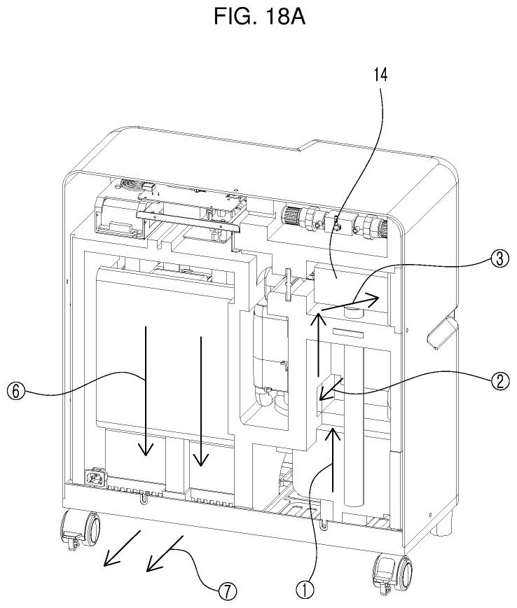

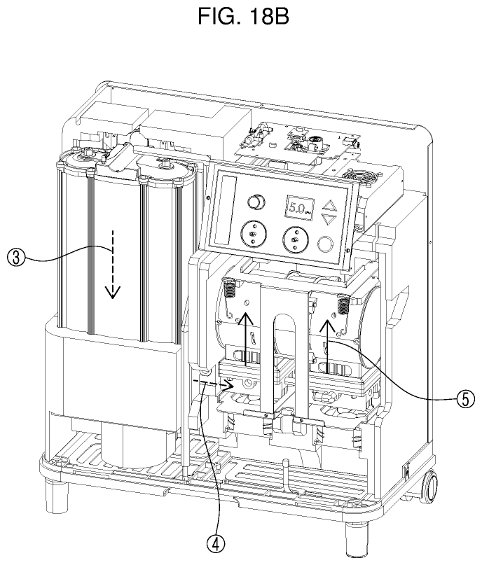

FIG. 15 is a diagram illustrating the cooling pathway of the oxygen supply apparatus 10 according to an embodiment of the present invention. Referring to FIG. 15, the air introduced through the air inlet 12 is directed through three cooling pathways to the second accommodating part 20 where the compressor 43 is located, and then discharged outside through the exhaust duct. Cooling pathway I is a pathway through which the air drawn in through the air inlet 12 passes through the space where the cooling fan 51 is located and then moves to the second accommodating part 20 where the compressor 43 is located. Cooling pathway II is a pathway through which the air drawn in through the air inlet 12 passes through a space where the intake silencer 16 is located, a space where the controller 18 is located, and a space where the cooling fan 51 is located, and then moves to the second accommodating part 20 where the compressor 43 is located. Cooling pathway III is a pathway through which the air drawn in through the air inlet 12 passes through a space where the intake air filter 14 is located, the adsorption beds 33 and 35 of the adsorption bed assembly 31, and the exhaust silencer 37, and then moves to the second accommodating part 20 where the compressor 43 is located. FIGS. 16A and 16B show the cooling pathway I, FIGS. 17A to 17C show the cooling pathway II, and FIGS. 18A and 18B show the cooling pathway III. Cooling pathways I, II, and III can be formed by the upper cover 13 and/or the lower cover 15, as described above.

Referring to FIGS. 16A and 16B, the cooling pathway I will be described. An intake air pathway \textcircled{1} leads to a cooling pathway \textcircled{2} through the air inlet 12. Then, a cooling pathway \textcircled{3} passing through a cooling fan room where the cooling fan 15 is located, and then, a cooling pathway \textcircled{4} passing through a compressor room where the compressor 43 is located is formed. Then, an exhaust duct pathway \textcircled{5} is formed by the upper cover 13, leading to an exhaust pathway \textcircled{6} where air is discharged into the atmosphere.

Referring to FIGS. 17A to 17C, the cooling pathway II will be described. An inlet air pathway \textcircled{1} leads to a cooling pathway \textcircled{2} through the air inlet 12. Then, the cooling pathway leads to a cooling pathway \textcircled{3} passing through an intake silencer room where the intake air silencer 62 is located. Then, the cooling pathway \textcircled{4} passing through a controller room where the controller 64 is located. In this regard, the cooling pathway \textcircled{4} passes through the controller room includes a downward-flowing pathway, as shown in FIG. 17B. Then, a cooling pathway \textcircled{5} passing through a cooling fan room where the cooling fan 51 is disposed is formed, and the cooling pathway \textcircled{6} passing through a compressor room where the compressor 43 is located. Then, an exhaust duct pathway \textcircled{7} formed by the upper cover 13 is formed, and an exhaust pathway \textcircled{8} where air is discharged into the atmosphere is formed.

Referring to FIGS. 18A and 18B, the cooling pathway III will be described. An inlet air pathway \textcircled{1} leads to a cooling pathway \textcircled{2} through the air inlet 12. Then, a cooling pathway \textcircled{3} passing through the intake air filter 14 and the adsorption bed assembly 13 is formed, and a cooling pathway \textcircled{4} corresponding to the flow of purged nitrogen exhausted from the adsorption bed assembly 31 is formed. Then, a cooling pathway \textcircled{5} passing through a compressor room where the compressor 43 is located is formed. Then, an exhaust duct ductway \textcircled{6} is formed by the upper cover 13, and then an exhaust ductway \textcircled{7} where air is discharged into the atmosphere is formed. Here, the former three cooling pathways \textcircled{1}, \textcircled{2}, and \textcircled{3} are formed by the flow of the intake air, and the latter four cooling pathways \textcircled{4}, \textcircled{5}, \textcircled{6}, and \textcircled{7} are formed by the flow of purged nitrogen. In an embodiment of the invention, the structure is implemented in a way that the purged nitrogen exhausted from the adsorption bed assembly 31 is mixed with intake air and then passes through the space where the compressor 43 is located to be discharged into the outside, thereby enhancing the cooling effect.

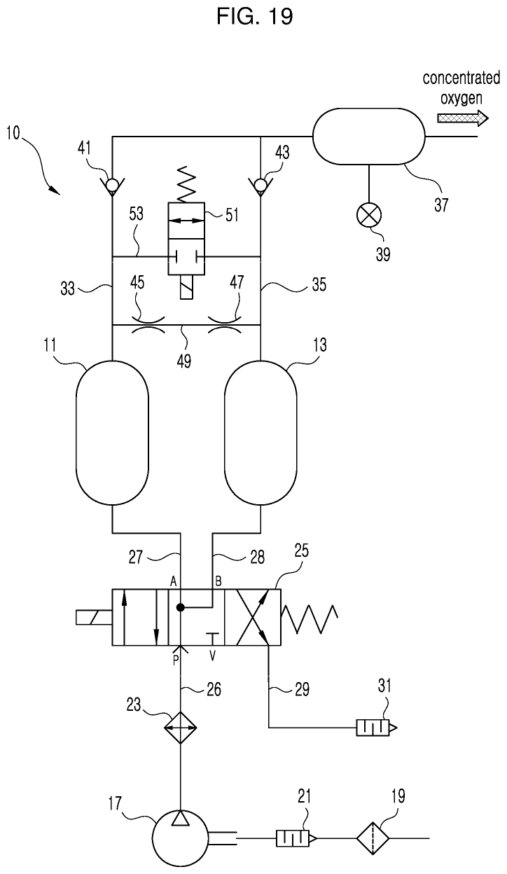

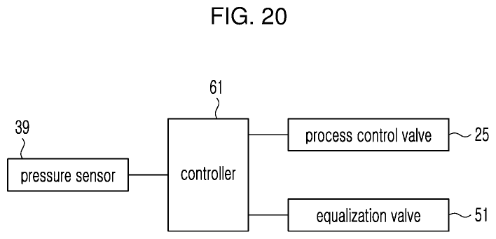

FIG. 19 schematically shows an oxygen supply apparatus according to an embodiment of the present invention, and FIG. 20 is a schematic block diagram of control elements of an oxygen supply apparatus according to an embodiment of the present invention. An oxygen supply apparatus 110 concentrates oxygen from a supply gas, for example, air, and supplies oxygen concentration gas.

The oxygen supply apparatus 110 includes both a first adsorption bed 111 and a second adsorption bed 113, which operate on a pressure swing adsorption process where nitrogen adsorption alternately occurs between the first and second beds, allowing for the generation of concentrated oxygen. As previously mentioned, the oxygen supply apparatus 110 can produce concentrated oxygen through nitrogen adsorption driven by pressurization and the discharge of adsorbed nitrogen. The first and second adsorption beds 111 and 113 are configured to alternate between these processes. In broad terms, while the first adsorption bed 111 generates concentrated oxygen through nitrogen adsorption, the second adsorption bed 113 releases adsorbed nitrogen, and vice versa, ensuring a continuous supply of concentrated oxygen.

The oxygen supply apparatus 110 is configured to perform a series of processes, including a pressurization process that supplies compressed air to pressurize the first adsorption bed 111 and generate concentrated oxygen, an upper equalization process that connects the upper ends of the first adsorption bed 111 and the second adsorption bed 113 to achieve upper pressure equalization, and a lower equalization process that connects the lower end of the first adsorption bed 111 and the lower end of the first adsorption bed 13 to achieve lower pressure equalization. Through these processes, the apparatus produces concentrated oxygen from compressed air.

The first and second adsorption beds 111 and 113 can generate oxygen-enriched gas by utilizing an adsorbent with nitrogen adsorption characteristics dependent on pressure, such as zeolite, to selectively remove nitrogen from the air and increase the oxygen concentration.

The compressor 117 compresses air and supplies compressed air. For example, the compressor 117 may be a BLDC compressor. Referring to FIG. 19, a filter 119 for removing impurities from the supplied air and a silencer 121 for reducing noise generated during air intake may be placed at the front end of the compressor 117. Additionally, an air cooler 123 for cooling the compressed air that has passed through the compressor 117 may be placed at the rear end of the compressor 117.

Compressed air discharged from the compressor 117 is supplied to first and second adsorption beds 111 and 113 through a process control valve 125. A process control valve 125 operates so that each process for production of concentrated oxygen is performed through flow channel control. The process control valve 125 may include four passages that are respectively connected to a supply passage 126 connected to the compressor 117, a passage 127 connected to the first adsorption bed 111, a passage 128 connected to the second adsorption bed 113, and a nitrogen discharge passage 129, and may realize three control positions. The three control positions include a first control position in which the supply passage 126 communicates with the passage 127 connected to the first adsorption bed 111 and the passage 128 connected to the second adsorption bed 113 communicates with the nitrogen discharge passage 129, a second control position in which the supply passage 126 communicates respectively with the passage 127 connected to the first adsorption bed 111 and the passage 128 connected to the second adsorption bed 113, and a third control position in which the supply passage 126 communicates with the passage 128 connected to the second adsorption bed 113 and the passage 127 connected to the first adsorption bed 111 communicates with the nitrogen discharge passage 129. A process of generating concentrated oxygen in the first adsorption bed 111 is carried out with the process control valve 125 in the first control position, and a process of generating concentrated oxygen in the second adsorption bed 113 is carried out with the process control valve 125 in the third control position. An upper and lower equalization process for pressure equalizations between the upper parts of the first and second adsorption beds 111 and 113 and between the lower part of the first and second adsorption beds 111 and 113 is carried out with the process control valve 125 in the second control position. In this sense, the process control valve 125 can be implemented as 4/3-way valve having four connection flow paths and three control positions.

The nitrogen captured in the first and second adsorption beds 111 and 113 is discharged through the nitrogen discharge line 129 via the process control valve 125. Referring to FIG. 19, a silencer 131 can be installed in the nitrogen discharge line 129 to reduce the noise generated during nitrogen discharge.

An oxygen tank 137 stores the concentrated oxygen generated by the first and second adsorption beds 111 and 113. Concentrated oxygen lines 133 and 135 for guiding the concentrated oxygen gas generated from the first and second adsorption beds 111 and 113 to the oxygen tank 137 are connected to the rear of the first and second adsorption beds 111 and 113, respectively. These concentrated oxygen lines 133 and 135 are connected to both the first and second adsorption beds 111 and 113 and the oxygen tank 137. Although not shown in the diagram, the oxygen in the oxygen tank 137 can be configured to be supplied for the required purposes. A pressure sensor 139 for detecting the pressure of the concentrated oxygen stored in the oxygen tank 1371 may be installed in the oxygen tank 137.

Check valves 141 and 143 can be installed in the concentrated oxygen lines 133 and 135 to prevent the reverse flow of concentrated oxygen. These check valves 141 and 143 are configured to allow concentrated oxygen discharged from the first and second adsorption beds 111 and 113 to flow through the concentrated oxygen lines 133 and 135 into the oxygen tank 137 while blocking the flow of concentrated oxygen in the opposite direction.

Referring to FIG. 19, one or more rinse orifices 145 and 147 may be installed in a first connecting line 49 that connects to the concentrated oxygen lines 133 and 135. Through these rinse orifices 145 and 147, some of the concentrated oxygen discharged alternately from the first and second adsorption beds 111 and 113 can be supplied to the opposite second and first adsorption beds 113 and 111. The concentrated oxygen supplied through the rinse orifices 145 and 147 can be used to clean the adsorption agent inside the adsorption beds 111 and 113. This allows for the alternating adsorption and cleaning of nitrogen in the first and second adsorption beds 111 and 113.

Furthermore, referring to FIG. 19, an upper equalization valve 151 may be installed in a second connecting line 153 that connects to the concentrated oxygen lines 133 and 135. The upper equalization valve 151 may be implemented as an on/off valve, and the concentrated oxygen lines 133 and 135 are interconnected to each other when the upper equalization valve 151 is in the on state and are blocked from each other when the upper equalization vale 151 is in the off state. The upper equalization process, which will be explained later, is performed with the upper equalization valve 151 in the on state, allowing concentrated oxygen from the higher-pressure adsorption bed 111 or 113 to move to the opposite adsorption bed 111 or 113 through the upper equalization valve 151.

The controller 161 may control to perform the upper equalization process through the control of the process control valve 125 and the upper equalization valve 151. For example, the controller 161 may control such that the upper equalization process is initiated when the pressure in either the first or second adsorption bed 111 or 113 reaches its maximum and is then performed for a predetermined period of time. Since the point at which the pressure in either the first or second adsorption bed 111 or 113 reaches its maximum is effectively the same as the point at which the pressure in the oxygen tank 137 reaches its maximum, the upper equalization process may be initiated at a time when the pressure in the oxygen tank 137 detected by a pressure sensor 139 reaches at its maximum. For example, referring to FIG. 20, the controller 161 controls the operations of the process control valve 125 and the upper equalization valve 151 based on the pressure signal from the pressure sensor 139 indicating the pressure inside the oxygen tank 137. Furthermore, as known in the art, the controller 161 may perform the necessary control to enable oxygen concentration by pressure swing adsorption method. The controller 161 can control to perform sequentially the following processes: a pressurization process of supplying pressurized air to the first adsorption bed 111 to pressurize the first adsorption bed 111 to produce concentrated oxygen; an upper equalization process of turning on the upper equalization valve 151 to equalize the pressures of the upper parts of the first and second adsorption beds 111 and 113; and an upper and lower equalization process of communicating the passages 127 and 128 connected to the input ends to each other by controlling the process control valve 125 to additionally equalize the pressures in the lower parts of the first and second adsorption beds 111 and 13. The controller 161 may include a microprocessor, a memory, and related hardware and can be programmed to control the execution of processes for generating and supplying concentrated oxygen.

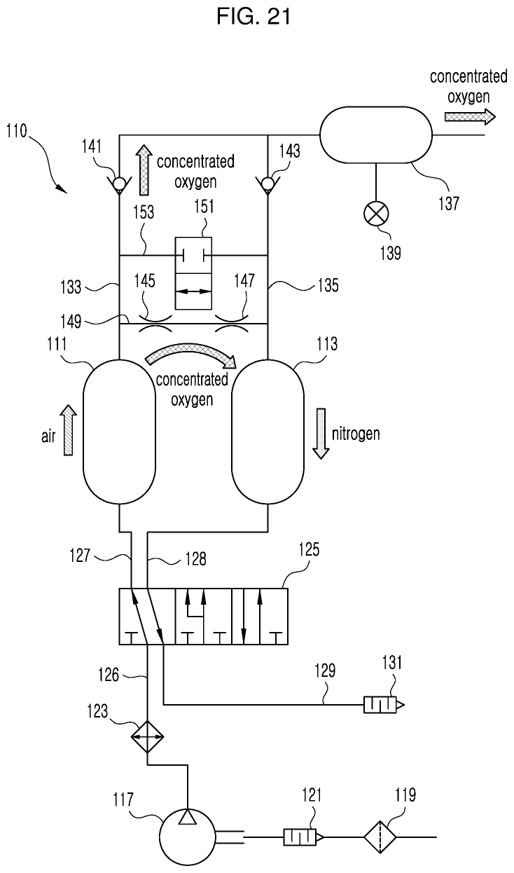

A portion of the concentrated oxygen discharged from the first adsorption bed 111 during the pressurization process of the first adsorption bed 111 is directed to the second adsorption bed 113 through rinse orifices 145 and 147 to be used for the cleaning of the second adsorption bed 113. In FIG. 21, it is shown that the first adsorption bed 111 is in the state of the pressurization process in which the first adsorption bed 111 is supplied with pressurized air and produces concentrated oxygen. During this process, compressed air provided by the compressor 117 is supplied to the first adsorption bed 111, resulting in the generation of concentrated oxygen, and the concentrated oxygen is then supplied to the oxygen tank 137 via the check valve 141. Δt the same time, a portion of the concentrated oxygen is directed to the second adsorption bed 1131 through the rinse orifices 145 and 147, initiating the cleaning process of the second adsorption bed 113. As a result of the rinse process, the nitrogen adsorbed in the second adsorption bed 113 is discharged to the outside through the process control valve 125 and the nitrogen discharge line 129.

The pressure with the second adsorption bed 113 generally increases during the upper equalization process and the upper and lower equalization process, and the controller 161 controls such that the pressurization process of the second adsorption bed 113 is performed after the completion of the upper and lower equalization process. This cycle of processes repeats to accomplish oxygen concentration through the pressure swing adsorption method. The fundamental processes of the pressure swing adsorption for oxygen concentration are well-known in the art to which this invention pertains, so a more detailed explanation is omitted.

The oxygen supply apparatus 110 according to an embodiment of the present invention is designed to ensure the purity of oxygen even in low-flow conditions while achieving low power consumption.

According to an embodiment of the present invention, the flow pressure drop of the tubular adsorption beds 111 and 113 are reduced to decrease the amount of concentrated oxygen for rinsing the adsorption beds 111 and 113, thereby reducing power consumption. To achieve this, the length of the adsorption beds 111 and 113 is made shorter compared to the conventional apparatus and the width of the adsorption beds 111 and 113 is increased, while reducing the diameter of the rinse orifices 145 and 147. This reduces the flow pressure drop, leading to a decrease in the amount of concentrated oxygen used for rinsing. The reduction in the amount of concentrated oxygen used for rinsing results in a reduction in the capacity of the compressor 117, which in turn leads to lower power consumption.

In another embodiment of the present invention, the cross-sectional area of the first and second adsorption beds 111 and 113 is increased while reducing their length, ensuring smooth flow of concentrated oxygen for rinsing, and this allows for more effective nitrogen adsorption with a smaller amount of rinse gas. Reducing the flow pressure drop in the adsorption beds 111 and 113 in this manner helps decrease the amount of rinse gas, which becomes one of the factors for lowering power consumption.

According to an embodiment of the present invention, it is configured that an optimization of the pressure swing adsorption process is made based on the usage flow rate. To achieve this, the ratio of an initial pressure, i.e., a maximum pressure and a final pressure, i.e., a minimum pressure is set to be smaller when the usage flow rate is smaller compared to when the usage flow rate is larger. For example, when the usage flow rate is in the high flow rate range, such as a range between 8.0 to 10.0 Lpm, the ratio of the minimum pressure to the maximum pressure may be set in a range of 75 to 85%. On the other hand, when the usage flow rate is in the low flow rate range, such as a range between 0.5 to 2.0 Lpm, the ratio of the minimum pressure to the maximum pressure may be set in a range of 45 to 55%. This means that, on one hand, a larger pressure drop occurs during the upper equalization process in the low flow rate range compared to the high flow rate range, and on the other hand, the duration of the upper equalization process is longer in the low flow rate range compared to the high flow rate range.

Even when a high-capacity compressor suitable for a high flow condition, e.g., a usage flow rate of 10 Lpm is applied, the oxygen concentration can be maintained even at low flow rates. However, applying a high capacity compressor may lead to the challenge of ensuring sufficient pressurization process time due to the large supply of air. To address this issue, conventional oxygen supply apparatus sometimes control the flow rate by venting a portion of the supply air to the outside through a separate bypass valve. However, this method results in increased power consumption. In contrast, according to an embodiment of the present invention, the ratio of the maximum pressure to the minimum pressure during the upper equalization process is increased for low flow conditions. This means that the duration of the upper equalization process is made sufficiently long. Due to the extended upper equalization process, a time for consuming oxygen can be ensured and at the same time this time period may be utilized for sending the high purity oxygen to the opposite adsorption bed to regenerate the zeolite. In other words, in the oxygen supply apparatus according to an embodiment of the present invention, in low flow conditions, instead of venting suppled air, oxygen is used for the regeneration (rinse) process of the opposite adsorption bed, and this reduces power consumption while ensuring sufficient regeneration to increase the purity of concentrated oxygen in subsequent processes.

Table 1 below shows process control parameters for each flow rate of the oxygen supply apparatus according to an embodiment of the present invention. As shown in Table 1, it can be seen that the pressure ratio of the lowest pressure to the highest pressure of the upper equalization process in the low flow rate section is set larger than that in the high flow rate section. Δt this time, as described above, the starting point of the upper equalization process can be determined based on the signal of the pressure sensor 139 that detects the pressure in the oxygen tank 137, and the upper equalization process is performed during the upper equalization time shown in Table 1. This ensures that the lowest value of the upper equalization process pressure range is achieved.

TABLE 1

| | | Upper | Pressure range of | | | | | | |
|---|---|---|---|---|---|---|---|---|---|
| Flow | | equalization | upper equalization | | | Pressure | Oxygen | Compressor | Consumption |
| rate | | time (sec) | process (bar) | | | ratio (%) | purity (%) | RPM | power (W) |
| 0.5 | Lpm | 3.5 | 1.70 bar | 0.925 | bar | 54.0% | 95.6 | 1,100 | 228 |
| 1.0 | Lpm | 3.5 | 1.65 bar | 0.85 | bar | 51.5% | 95.6 | 1,100 | 228 |
| 1.5 | Lpm | 3.5 | 1.70 bar | 0.85 | bar | 50.0% | 95.5 | 1,100 | 228 |
| 2.0 | Lpm | 3.2 | 1.75 bar | 0.90 | bar | 51.5% | 95.6 | 1,100 | 231 |
| 5.0 | Lpm | 1.5 | 1.85 bar | 1.30 | bar | 70% | 95.1 | 1,150 | 257 |
| 10.0 | Lpm | 0.7 | 2.30 bar | 1.90 | bar | 82.6% | 94.4 | 1,750 | 393 |

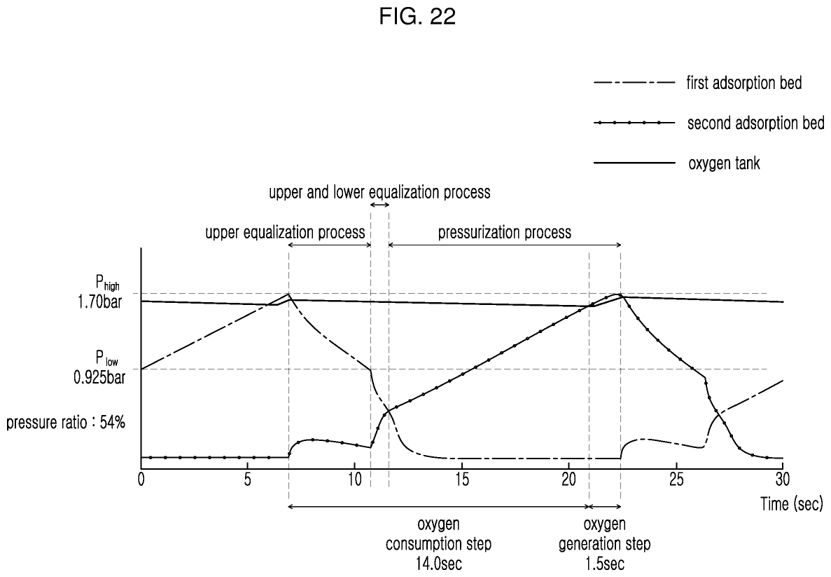

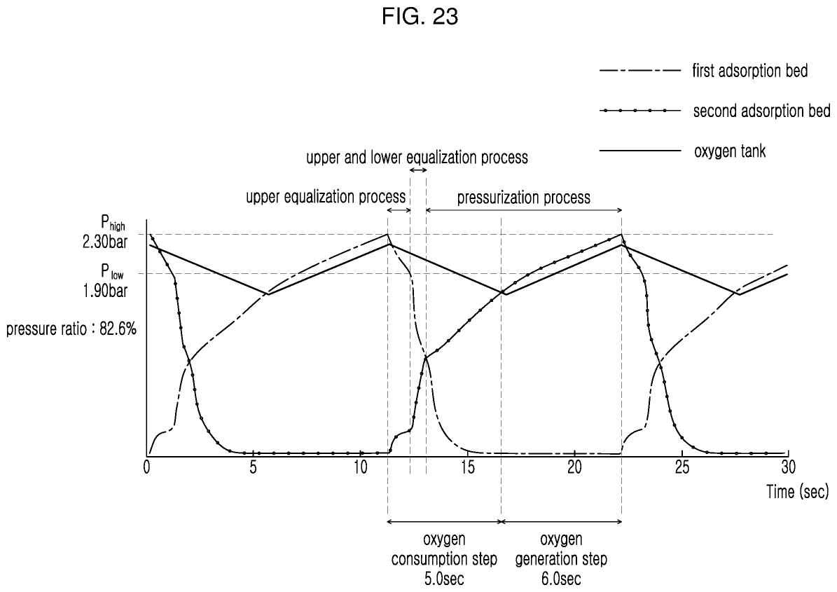

FIG. 22 shows the pressure profiles within the first and second adsorption beds during the operation of the oxygen supply apparatus according to an embodiment of the present invention, particularly in the low flow range, where the flow rate is 0.5 Lpm. On the other hand, FIG. 23 shows the pressure profiles within the first and second adsorption beds during the operation of the oxygen supply apparatus according to an embodiment of the present invention, especially in the high flow range, where the flow rate is 10.0 Lpm.

Referring to FIG. 22, at a flow rate of 0.5 Lpm, the maximum pressure P_{high} within the first adsorption bed during the upper equalization process is 1.70 bar, and the minimum pressure P_{low} is 0.925 bar. Therefore, the ratio of the minimum pressure P_{low} to the maximum pressure P_{high} is 54%. The duration time of the oxygen consumption step including the upper equalization process, the upper and lower equalization process and an early portion of the pressurization process is 14 seconds, and the duration time of the oxygen generation step including a late portion of the pressurization process is 1.5 seconds.

Referring to FIG. 23, at a flow rate of 10.0 Lpm, the maximum pressure P_{high} within the first adsorption bed during the upper equalization process is 2.30 bar, and the minimum pressure P_{low} is 1.90 bar. Therefore, the ratio of the minimum pressure P_{low} to the maximum pressure P_{high} is 82.6%. In this case, the duration of the oxygen consumption step is 5.0 seconds, and the duration of the oxygen generation step is 6.0 seconds.

Comparing FIGS. 22 and 23, compared to the high flow rate section, in the low flow rate section, the ratio of the minimum pressure to the maximum pressure of the adsorption bed (the first adsorption bed in FIGS. 22 and 23) in which the pressure therein decreases during the upper equalization process is smaller and the duration time of the consumption step is longer. This results in an increased amount of concentrated oxygen being supplied to the opposite adsorption bed during the consumption process, allowing for sufficient cleaning of the opposite adsorption bed. This leads to a reduction in power consumption and an increase in the purity of the concentrated oxygen.

The method described above in accordance with an embodiment of the present invention allows for a significant reduction in power consumption per Lpm compared to conventional apparatus. For example, in a conventional oxygen supply apparatus, the power consumption per 1 Lpm is 52 w/Lpm, while in the oxygen supply apparatus according to an embodiment of the present invention, the power consumption per 1 Lpm is reduced to 39.5 w/Lpm. This represents a notable improvement in energy efficiency.

According to an embodiment of the present invention, an oxygen supply method uses an oxygen supply apparatus comprising a first adsorption bed and a second adsorption bed to supply concentrated oxygen by a pressure swing adsorption method. The method includes a pressurization process in which compressed air is supplied to the first adsorption bed to pressurize the first adsorption bed to generate concentrated oxygen by a pressure swing adsorption method, an upper equalization process in which the rear ends of the first and second adsorption beds are communicated with each other so that at least a portion of the concentrated oxygen discharged from the first adsorption bed flows into the second adsorption bed, and an upper and lower equalization process in which the front ends of the first and second adsorption beds are communicated with each other. The upper equalization process is performed such that the ratio of the maximum pressure of the process pressure profile in the first adsorption bed to the minimum pressure thereof is different from each other in a high flow rate region and a low flow rate region where a flow rate is lower than the high flow rate region. Here, a ratio of a minimum pressure to a maximum pressure of the process pressure profile within the first adsorption bed during the upper equalization process is set to be smaller in the low flow rate region than in the high flow rate region.

The oxygen supply apparatus 110 according to an embodiment of the present invention is configured to have a function of detecting the usage of concentrated oxygen. For example, a user may use concentrated oxygen at a flow rate of 10 Lpm and then reduce the flow rate, during which no input may be provided to the oxygen generation unit. Especially, in cases where there is a separate flow control apparatus on the user's side to adjust the oxygen flow rate, the oxygen generation unit cannot electrically or physically detect the flow rate change. In such cases, the oxygen generation unit operates only at the 10 Lpm process, resulting in high power consumption. Therefore, the usage detection function is incorporated to perform a process corresponding to the required flow rate, thereby reducing power consumption, especially for low flow processes. Oxygen usage is typically detected through a flow sensor installed in the oxygen discharge line and measured by a flow meter. However, in such cases, there may be additional costs or side effects related to oxygen pressure drop. Considering these points, in an embodiment of the present invention, it is configured to detect oxygen usage through the existing pressure swing adsorption process unit without the installation of additional equipment.

Specifically, the usage flow rate (F, unit of Lpm) can be calculated using the following equation 1. In this case, the usage flow rate can be determined in the consumption process, which includes the upper equalization process, lower equalization process, and pressurization process.

$$F = L \frac{Δ P}{Δ t} 60 \qquad [ Equation 1 ]$$

Here, L represents the volume (in liters) of the oxygen tank, ΔP is the difference (in bars) between the maximum and minimum pressures within the oxygen tank during the consumption process, and Δt is the time interval (in seconds) between the moments of maximum and minimum pressure within the oxygen tank during the consumption process.

The controller 161 is configured to perform process control based on the usage flow rate calculated according to the equation 1. For example, if the calculated usage flow rate changes from 10 Lpm (liters per minute), which was the reference, to 2 Lpm, the controller can adjust the control to the low flow process accordingly.

While particular embodiments of the present invention have been shown and described, modifications may be made. It is therefore intended in the appended claims to cover all such changes and modifications which fall within the true spirit and scope of the invention as defined by those claims.

What is claimed is:

1. An apparatus for supplying oxygen comprising:
a compressor assembly configured to compress air and supply compressed air;
an adsorption bed assembly comprising a plurality of adsorption beds configured to adsorb nitrogen from the compressed air supplied by the compressor assembly through a pressure swing adsorption process to produce concentrated oxygen;
a cover formed to surround the compressor assembly and the adsorption bed assembly; and
a cover configured to accommodate the cover and having an air inlet through which air supplied to the compressor assembly flows,
wherein the cover is configured to allow the air supplied through the air inlet to pass through a space where the compressor assembly is disposed and then be discharged to an outside.

2. The apparatus of claim 1, wherein the compressor assembly comprises a compressor configured to compress the air, and a support frame for supporting the compressor, and
wherein the compressor is supported on the support frame in an upside-down state so that a head is positioned downward.

3. The apparatus of claim 2, wherein the compressor is supported on the support frame in a suspended state by a plurality of springs.

4. The apparatus of claim 2, further comprising a cooling fan disposed below the support frame,
wherein the support frame comprises an air inlet configured so that air flowing by the cooling fan moves upward and flows into the head of the compressor.

5. The apparatus of claim 1, wherein the cover comprises a first accommodating part in which the adsorption bed assembly is disposed, a second accommodating part in which the compressor assembly is disposed, and a partition wall dividing the first accommodating part and the second accommodating part, and
wherein the partition wall comprises a connection passage connecting the first accommodating part and the second accommodating part so that purge nitrogen discharged from the adsorption bed assembly is able to move to the second accommodating part.

6. The apparatus of claim 1, further comprising a heat exchanger disposed below the compressor assembly and the adsorption bed assembly.

7. The apparatus of claim 1, wherein the cover is formed of foam.

8. The apparatus of claim 7, wherein the foam is EPP foam.

9. The apparatus of claim 1, wherein the cover comprises a pair of lower covers formed to surround a lower portion of the adsorption bed assembly, and a pair of upper covers formed to surround an upper portion of the adsorption bed assembly and the compressor assembly.

10. The apparatus of claim 1, wherein the cover comprises a first accommodating part in which the adsorption bed assembly is disposed, a second accommodating part in which the compressor assembly is disposed, and a partition wall dividing the first accommodating part and the second accommodating part,
wherein the cover is configured to form a first to third cooling pathway formed by air supplied through the air inlet and purge nitrogen discharged from the adsorption bed assembly,
wherein the first cooling pathway is configured so that the air introduced through the air inlet sequentially passes through a space where the compressor assembly is placed, the partition wall, and a side where the adsorption bed assembly is placed, and is then discharged to the outside,
wherein the second cooling pathway is configured so that air introduced through the air inlet sequentially passes through the partition wall, a space where the controller is placed, the partition wall, a space where the compressor is placed, the partition wall, and a side where the adsorption bed assembly is placed, and is then discharged to the outside, and
wherein the third cooling pathway is configured so that air introduced through the air inlet flows into an intake air filter and the adsorption bed assembly, and purge nitrogen discharged from the adsorption bed assembly sequentially flows through the partition wall, a space where the compressor assembly is placed, the partition wall, and a side where the adsorption bed assembly is placed, and is then discharged to the outside.

11. An apparatus for supplying oxygen comprising:
a compressor that supplies compressed air;
a first adsorption bed and a second adsorption bed for generating concentrated oxygen by alternately adsorbing nitrogen from the compressed air supplied by the compressor by a pressure swing adsorption method;
a process control valve configured to adjust flow of the compressed air supplied to the first and second adsorption beds and passages for discharging adsorbed nitrogen discharged from the first and second adsorption beds;
an upper equalization valve configured to selectively communicate with a first concentrated oxygen passage and a second concentrated oxygen passage for guiding the concentrated oxygen respectively discharged from the first and second adsorption beds; and
a controller that controls the process control valve and the upper equalization valve respectively based on process pressures in the first and second adsorption beds,
wherein the controller controls to perform a pressurization process in which the pressurized air is supplied to the first adsorption bed to pressurize the first adsorption bed and generate the concentrated oxygen, an upper equalization process in which the first and second oxygen passages are communicated with each other by the upper equalization valve to allow at least a portion of the concentrated oxygen discharged from the first adsorption bed to flow into the second adsorption bed, and an upper and lower equalization process in which lower ends of the first and second adsorption beds are communicated with each other,
wherein the controller controls such that a ratio of a minimum pressure to a maximum pressure of a process pressure profile in the first adsorption bed during the upper equalization process is different from each other in a high flow rate region and a low flow rate region where a flow rate is lower than the high flow rate region, and
wherein the controller controls such that a ratio of the minimum pressure to the maximum pressure of the process pressure profile within the first adsorption bed during the upper equalization process is set to be smaller in the low flow rate region than in the high flow rate region.

12. The apparatus of claim 11, wherein in the low flow rate region the ratio of the minimum pressure to the maximum pressure in the process pressure profile within the first adsorption bed during the upper equalization process is a value in a range of 45 to 55%, and
wherein in the high flow rate region the ratio of the minimum pressure to the maximum pressure of the process pressure profile in the first adsorption bed during the upper equalization process is a value in the range of 75 to 85%.

13. The apparatus of claim 11, wherein a duration time of the upper equalization process in the low flow rate section is set to be longer than the duration time of the upper equalization process in the high flow rate section.

14. The apparatus of claim 11, further comprising one of more rinse orifices installed in a connection passage connecting the first concentrated oxygen passage and the second concentrated oxygen passage.

15. The apparatus of claim 11, wherein the controller is configured to perform process control based on usage flow rate calculated by the following equation
$$F = L \frac{Δ P}{Δ t} 60 \qquad [ Equation ]$$
Here, L is a volume of an oxygen tank, ΔP is a difference between a maximum pressure and a minimum pressure in the oxygen tank during a consumption process of consuming oxygen, and Δt is a time interval between a point of a maximum pressure and a point of a minimum pressure with the oxygen tank during the consumption process.

16. An apparatus for supplying oxygen comprising:
a compressor that supplies compressed air;
a first adsorption bed and a second adsorption bed for generating concentrated oxygen by alternately adsorbing nitrogen from the compressed air supplied by the compressor by a pressure swing adsorption method;
a process control valve configured to adjust flow of the compressed air supplied to the first and second adsorption beds and passages for discharging adsorbed nitrogen discharged from the first and second adsorption beds;
an upper equalization valve configured to selectively communicate with a first concentrated oxygen passage and a second concentrated oxygen passage for guiding the concentrated oxygen respectively discharged from the first and second adsorption beds; and
a controller that controls the process control valve and the upper equalization valve respectively based on process pressures in the first and second adsorption beds,
wherein the controller controls to perform a pressurization process in which the pressurized air is supplied to the first adsorption bed to pressurize the first adsorption bed and generate the concentrated oxygen, an upper equalization process in which the first and second oxygen passages are communicated with each other by the upper equalization valve to allow at least a portion of the concentrated oxygen discharged from the first adsorption bed to flow into the second adsorption bed, and an upper and lower equalization process in which lower ends of the first and second adsorption beds are communicated with each other,
wherein the controller is configured to perform a process control based on usage flow rate calculated by the following equation
$$F = L \frac{Δ P}{Δ t} 60 \qquad [ Equation ]$$
Here, L is a volume of an oxygen tank, ΔP is a difference between a maximum pressure and a minimum pressure in the oxygen tank during a consumption process of consuming oxygen, and Δt is a time interval between a point of a maximum pressure and a point of a minimum pressure with the oxygen tank during the consumption process.

17. A method for supplying oxygen using a first adsorption bed and a second adsorption bed each configured to produce concentrated oxygen by nitrogen adsorption, and an oxygen tank configured to store the concentrated oxygen produced by the first and second adsorption beds, to supply concentrated oxygen in a pressure swing adsorption method, comprising:
a pressurization process in which pressurized air is supplied to the first adsorption bed to pressurize the first adsorption bed and generate the concentrated oxygen;
an upper equalization process in which rear ends of the first and second adsorption beds are communicated with each other to allow at least a portion of the concentrated oxygen discharged from the first adsorption bed to move to the second adsorption bed; and
an upper and lower equalization process in which lower ends of the first and second adsorption beds are communicated with each other,
wherein the upper equalization process is performed such that a ratio of a minimum pressure to a maximum pressure of a process pressure profile in the first adsorption bed during the upper equalization process is different from each other in a high flow rate region and a low flow rate region where a flow rate is lower than the high flow rate region, and
wherein a ratio of the minimum pressure to the maximum pressure of the process pressure profile within the first adsorption bed during the upper equalization process is set to be smaller in the low flow rate region than in the high flow rate region.

18. The method of claim 17, wherein in the low flow rate region the ratio of the minimum pressure to the maximum pressure in the process pressure profile within the first adsorption bed during the upper equalization process is a value in a range of 45 to 55%, and
wherein in the high flow rate region the ratio of the minimum pressure to the maximum pressure of the process pressure profile in the first adsorption bed during the upper equalization process is a value in the range of 75 to 85%.

19. The method of claim 17, wherein a duration time of the upper equalization process in the low flow rate section is set to be longer than the duration time of the upper equalization process in the high flow rate section.

20. The method of claim 17, wherein the process control is performed based on usage flow rate calculated by the following equation
$$F = L \frac{Δ P}{Δ t} 60 \qquad [ Equation ]$$
Here, L is a volume of an oxygen tank, ΔP is a difference between a maximum pressure and a minimum pressure in the oxygen tank during a consumption process of consuming oxygen, and Δt is a time interval between a point of a maximum pressure and a point of a minimum pressure with the oxygen tank during the consumption process.
